(19) United States
(12) Patent Application Publication
(10) Pub. No.: US 2006/0132624 A1
(43) Pub. Date: Jun. 22, 2006

(54) Electronic camera with noise reduction unit

(75) Inventor: Masami Yuyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/287,953

(22) Filed: Nov. 28, 2005

(30) Foreign Application Priority Data
Dec. 21, 2004 (JP) 2004-368626
Dec. 27, 2004 (JP) 2004-375241

(51) Int. Cl. H04N 5/217

(52) U.S. Cl. 348/241

(57) ABSTRACT

An image and sound recording operation is performed, and image data is successively recorded on a memory (S201). It is judged whether or not a current waveform has reached a threshold value to determine if the current waveform becomes ON (S202). When the current waveform is not ON, sound data detected by a microphone is stored in the memory at step S205 without performing processes at steps S203 and S204. When the current waveform is ON, and a zoom motor starts its rotation, zoom sound data previously stored in the memory is read out therefrom at step S203. Further, a subtracting process is performed at step S204 to subtracting a zoom sound from sound data of the surroundings obtained by the microphone and an audio signal processing circuit, and the resultant data is stored in the memory as sound data to be stored at step S205.

### BACKGROUND OF THE INVENTION

1. Field of the Invention

The present invention relates to an electronic camera, noise reduction device and method of reducing noises, which are capable of reducing noises produced by operation of an operating unit such as an electric motor installed in various apparatuses.

2. Prior Art

A conventional camera is capable of recording a photographed image together with sounds obtained while the image is photographed, and it is proposed to install in such conventional camera a noise reducing device which reduces noises produced by operation of a zoom motor to prevent noises from being incorporated with sounds to be recorded. When an operation of a zoom key is detected and a zoom motor starts its operation in response to the zoom key operation, the noise reducing device decreases sounds picked up by a microphone to a certain level to prevent operating sound of the zoom motor from being recorded.

### SUMMARY OF THE INVENTION

According to one aspect of the invention, there is provided an electronic camera which comprises an image photographing unit for photographing a moving image, a detecting unit for detecting sounds from the surroundings while the moving image is being photographed by the image photographing unit, a recording unit for recording the moving image photographed by the image photographing unit and the sounds detected by the detecting unit, an operating unit driven by a current, a noise reducing unit for performing a noise reducing operation to reduce noises produced by operation of the operating unit, and a control unit for judging, on the basis of a current waveform of the current for driving the operating unit, whether or not the noise reducing unit should perform the noise reducing operation.

According to other aspect of the invention, there is provided a noise reduction device which comprises an operating unit driven by a current, a noise reducing unit for performing a noise reducing operation to reduce noises produced by operation of the operating unit, and a control unit for judging, on the basis of a current waveform of the current for driving the operating unit, whether or not the noise reducing unit should perform the noise reducing operation.

According to still other aspect of the invention, there is provided a method of reducing noises which comprises the steps of detecting a current waveform of a current for driving an operating unit, and making a noise-reduction processing unit start a noise reduction process to reduce noises produced by operation of the operating unit, in response to detected current waveform of the current.

According to another aspect of the invention, there is provided an electronic camera which comprises an image photographing unit for photographing a moving image, a detecting unit for detecting sounds from the surroundings while the moving image is being photographed by the image photographing unit, a recording unit for recording the moving image photographed by the image photographing unit and the sounds detected by the detecting unit, an operating unit driven by a current, a pseudo-noise generating unit for generating pseudo noises similar to noises produced by operation of the operating unit, a synthesized waveform generating unit for synthesizing a current waveform of the current for driving the operating unit and the pseudo noises generated by the pseudo-noise generating unit to produce a synthesized waveform noise, and a subtracting unit for subtracting the synthesized waveform noise produced by the synthesized waveform generating unit from the sounds detected by the detecting unit.

According to still another aspect of the invention, there is provided a noise reduction device which comprises a detecting unit for detecting noises from the surroundings, an operating unit driven by a current, a pseudo-noise generating unit for generating pseudo noises similar to noises produced by operation of the operating unit, a synthesized waveform generating unit for synthesizing a current waveform of the current for driving the operating unit and the pseudo noises generated by the pseudo-noise generating unit to produce a synthesized waveform noise, and a subtracting unit for subtracting the synthesized waveform noise produced by the synthesized waveform generating unit from the sounds detected by the detecting unit.

According to yet another aspect of the invention, there is provided a method of reducing noises which comprises the steps of detecting sounds from the surroundings, generating pseudo noises similar to noises produced by operation of an operating unit driven by a current, synthesizing a current waveform of the current for driving the operating unit and the generated pseudo noises to produce a synthesized waveform noise, and subtracting the produced synthesized waveform noise from the sounds detected by the detecting unit.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing a circuit configuration of a digital camera according to the first embodiment of the present invention;

FIG. 2 is a block diagram showing an audio signal processing circuit in detail;

FIG. 3 is a view showing a circuit of the section “A” surrounded by a broken line in FIG. 1;

FIG. 4 is a flow chart showing processes to be performed in a zoom (AF) sound recording mode;

FIG. 5 is a view showing a waveform and a threshold voltage;

FIG. 6 is a flow chart showing processes to be performed in a movie recording mode;

FIG. 7 is a view showing the main portion of a digital camera according to the second embodiment of the present invention;

FIG. 8 is a block diagram showing a circuit configuration of a digital camera according to the third embodiment of the present invention;

FIG. 9 is a block diagram showing in detail an audio signal processing block shown in FIG. 8;

FIG. 10A is a view showing a current waveform;

FIG. 10B is a view showing a pseudo motor-sound waveform;

FIG. 10C is a view showing a synthesized waveform;

FIG. 11 is a view showing a circuit of the section “A” surrounded by a broken line in FIG. 8; and

FIG. 12 is a block diagram showing in detail an audio signal processing block in the fourth embodiment.

### PREFERRED EMBODIMENTS OF THE INVENTION

### First Embodiment

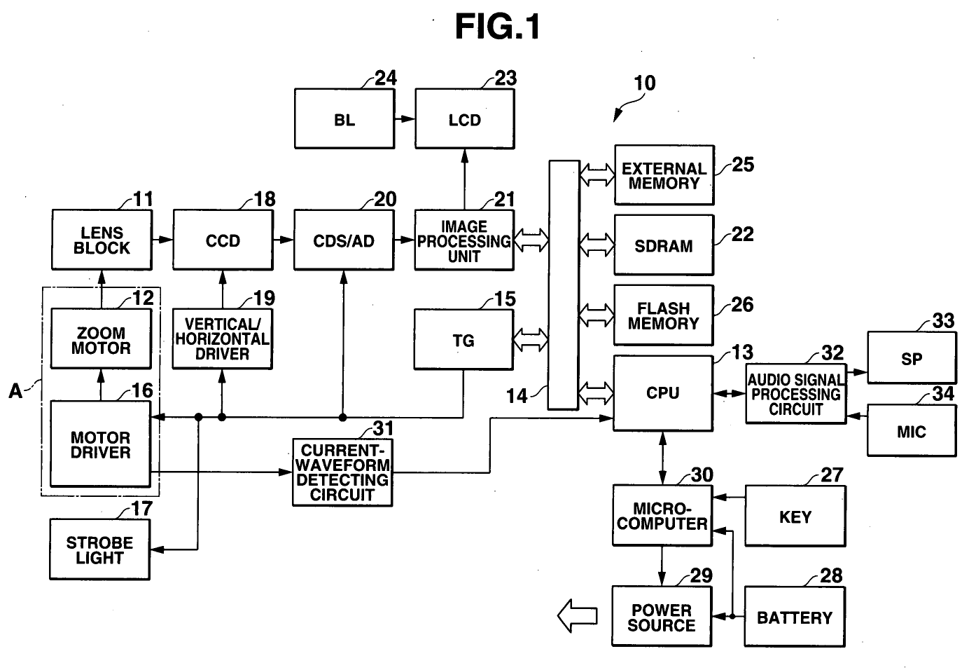

Now, digital cameras according to the embodiments of the invention will be described in detail with reference to the accompanying drawings. FIG. 1 is a block diagram showing a circuit configuration of a digital camera 10 according to the first embodiment of the invention. The digital camera 10 has general functions of camera such as AE (Automatic Exposure control function), AWB (Automatic White Balance control function), AF (Automatic Focus control function) and the like. A lens block 11 includes an optical system such as a zoom-lens system, an automatic focusing lens system and the like, and a driving mechanism for driving the optical system. The optical system is driven in the optical-axis direction by a zoom motor (DC motor) 12 provided in the driving mechanism. CPU 13 controls the whole operation of the digital camera 10, and is connected with a motor driver 16 through a bus 14 and a timing-signal generator (TG) 15. The motor driver 16 drives the zoom motor 12 on the basis of a timing signal which is generated by the timing-signal generator 15 in accordance with an instruction given by CPU 13. A strobe light 17 is also driven in accordance with the timing signal generated by the timing-signal generator 15. In practice, the digital camera 10 is provided with a focus motor and motor driver for driving the focusing lens system, and also a mechanical shutter, a mechanical aperture, and a driving mechanism for driving them, but these elements are not illustrated in FIG. 1 for simplicity.

Further, the digital camera 10 has CCD 18, which serves as an image pick-up element. CCD 18 is disposed along the optical axis of the lens block 11. An image of an object to be photographed is focused on a light receiving surface of CCD 18 by the lens block 11. CCD 18 is driven by a vertical/horizontal driver 19 on the basis of the timing signal which is generated by the timing-signal generator 15 in accordance with the instruction of CPU 13, generating analog photographed image signal corresponding to an optical image of the object. The analog photographed image signal is supplied to a unit circuit 20. The unit circuit 20 comprises CDS circuit which deletes noises involved in a signal output from CCD 18, using the correlated double sampling method, and A/D converter which converts the photographed image signal with noises deleted into a digital signal. The digitalized photographed-image signal is output to an image processing unit 21.

The image processing unit 21 performs a pedestal clumping process on the input photographed image signal, and separates the processed signal into a luminance (Y) signal and a color-difference (UV) signal. Further, the image signal is subjected to digital signal processes for enhancing image quality, such as an automatic white balance control process, edge enhancing process, and pixel interpolating process in the image processing unit 21. YUV data converted by the image processing unit 21 is successively stored in SDRAM 22, and is converted into a video signal every storage of image data of one frame in REC through mode, and further sent to a liquid crystal display monitor (LED) 23 provided with a back light, whereby a through image is displayed on LED 23.

In a still-image photographing mode, triggered by a shutter-key operation, CPU 13 gives CCD 18, the vertical/horizontal driver 19, unit circuit 20 and image processing unit 21 an instruction of switching a through-image photographing mode to the still-image photographing mode. Image data obtained by a photographing process and temporarily stored in SDRAM 22 in the still-image photographing mode is compressed by CPU 13 to be finally recorded on an external memory 25 as a still-image file in a certain format. Further, in a movie recording mode, plural pieces of image data successively stored in SDRAM 22 during a time between the first and second shutter-key operation are successively compressed by CPU 13 and recorded in the external memory 25 as a moving image file. The still-image file and moving image file recorded on the external memory 25 are read out and extended by CPU 13 in response to a selecting operation by a user, and expanded on SDRAM 22 as YUV data to be displayed on the liquid crystal display monitor 23.

In a flash memory 26 are stored various sorts of programs for CPU 13 to control the above elements and units, including programs for controlling AE, AF and AWB control operation and a data-communication program, and further various sorts of programs for making CPU 13 serve as a noise-reduction processing unit and control unit.

Further, the digital camera 10 comprises a key input unit 27, rechargeable battery 28 such a nickel-hydride battery, power control circuit 29 for supplying electric power of the battery to various elements and units, and a micro-computer 30 for controlling the above elements and units in the digital camera 10. The key input unit 27 includes plural operation keys and switches such as a power switch, mode selecting key, shutter key, and zoom key. The micro-computer 30 scans constantly to judge whether any one of operation keys in the key input unit 27 has been operated. When one of operation keys has been operated by the user, the micro-computer 30 sends CPU 13 an operation signal corresponding the operated operation key. A current-waveform detecting circuit 31 detects a waveform of current supplied to the zoom motor 12 (voltage of current waveform of the motor driver 16), and outputs it to CPU 13.

Further, the digital camera 10 has a recording function of recording sounds from the surroundings in the movie recording mode. CPU 13 is connected with a speaker (SP) 33 and microphone (MIC) 34 through an audio signal processing circuit 32. The audio signal processing circuit 32 processes a sound waveform entered from the microphone 34, and supplies sound waveform data to CPU 13 in the movie recording mode. CPU 13 compresses sound waveform data supplied from the audio signal processing circuit 32 during a time between the first and second shutter key operation in the movie recording mode to produce a moving image file with sounds accompanied, including the compressed sound data and compressed moving image data, and records the produced moving image file in the external memory 25. The moving image file with sounds accompanied, recorded in the external memory 25 is processed in PLAY mode such that sound data is converted into a sound waveform by the audio signal processing circuit 32 to be reproduced through the speaker 33, while the moving image data is being reproduced. Sounds may be recorded not only at the time when a moving image is photographed but also at the time when a recording operation is performed in the still-image photographing mode for photographing a moving image with sounds accompanied, or at the time the recording operation is performed in the recording mode or in the after recording mode.

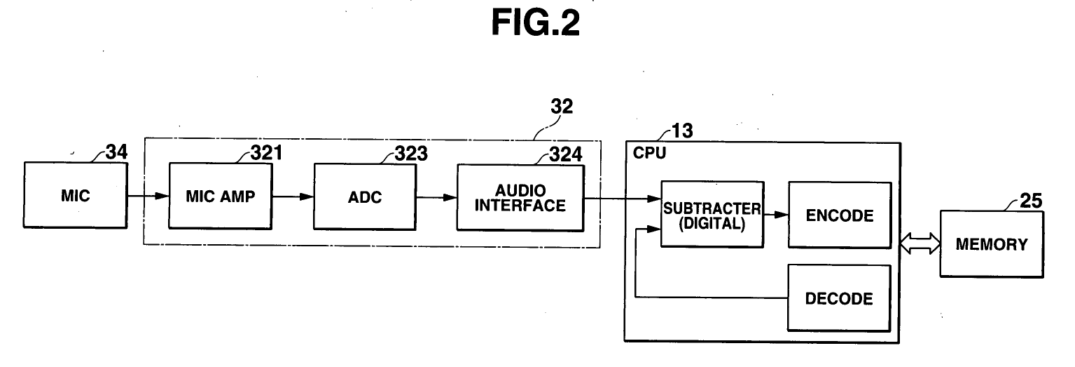

FIG. 2 is a block diagram showing the audio signal processing circuit 32 in detail. As shown in FIG. 2, the audio signal processing circuit 32 is connected with the microphone 34 and CPU 13. The audio signal processing circuit 32 comprises a microphone amplifier (MIC AMP) 321, AD converter (ADC) 323, and audio interface 324. In a zoom sound recording mode to be described below, a zoom sound entered through the microphone 34 is amplified by the microphone amplifier 321, and converted into zoom sound data by AD converter 323. The zoom sound data is sent to CPU 13 through the audio interface 324. At this time, CPU 13 does not serve as a subtracter, but encodes the zoom sound data obtained during a time duration between the leading edge and trailing edge of current waveform and stores the encoded data in the flash memory 26.

Further, in the movie recording mode to be described in detail below, when the current waveform rises, CPU 13 reads out zoom sound data from the flash memory 26 and decodes the data. CPU 13 serves as a subtracter in the movie recording mode to subtract the zoom sound waveform from sound data supplied from the microphone 34 through the audio signal processing circuit 32. CPU 13 encodes the sound data with the zoom sound waveform subtracted, and stores the encoded sound data in the external memory 25.

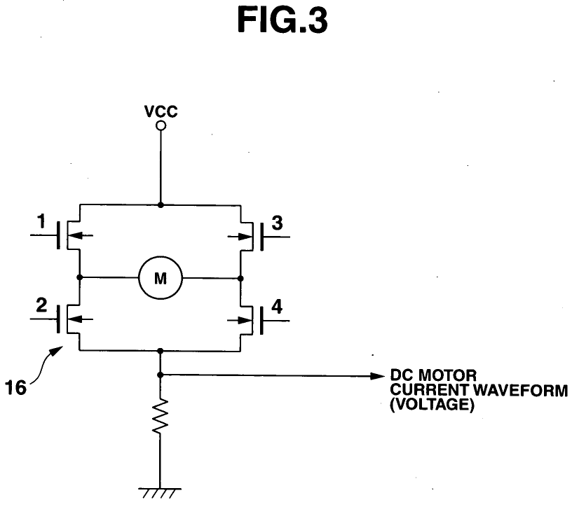

FIG. 3 is a view showing in detail a circuit of the section “A” surrounded by a broken line in FIG. 1, including the zoom motor 12 and motor driver 16. The motor driver 16 comprises a parallel connection of a series connection of switches 1 and 2 and a series connection of switches 3 and 4, and the zoom motor 12 is connected between a connecting point of the switches 1 and 2 and a connecting point of the switches 3 and 4, as shown in FIG. 3. When the switches 1 and 4 are turned on, the zoom motor 12 rotates in the normal direction, and on the contrary, when the switches 2 and 3 are turned on, then the zoom motor 12 rotates in the reverse direction. Current waveforms shown at the time when the switches 1 and 4 are turned on and at the time the switches 1 and 4 are turned on are detected between the switches 2, 4 and the earth, and supplied to the current-waveform detecting circuit 31.

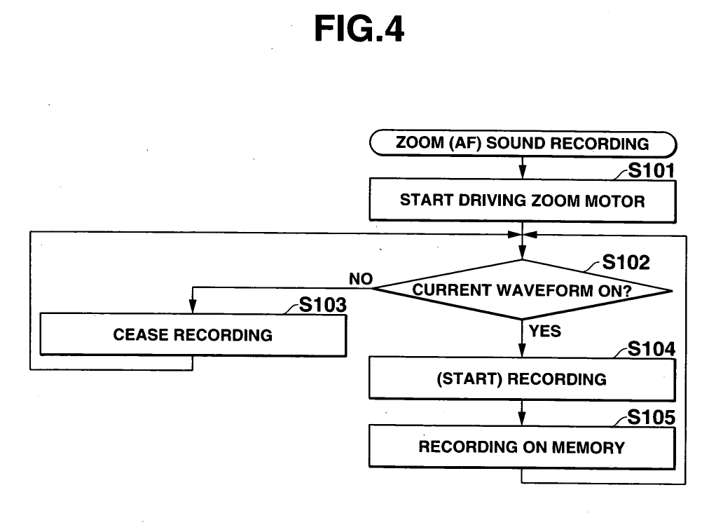

In the arrangement of the present embodiment of the invention, the user operates the mode selecting key to set the zoom sound recording mode, and further operates a noise registering key provided in, the key input unit 27 in quiet surroundings. Then, CPU 13 operates in accordance with the program to perform processes as shown in the flow chart of FIG. 4. The switches 1, 4 or switches 2, 3 in the motor driver 16 are made turned on to start driving the zoom motor 12 at step S101, whereby the zoom lens staying at a certain initial position is moved toward the critical position. Then, it is judged at step S102 whether or not the current waveform has risen or become ON.

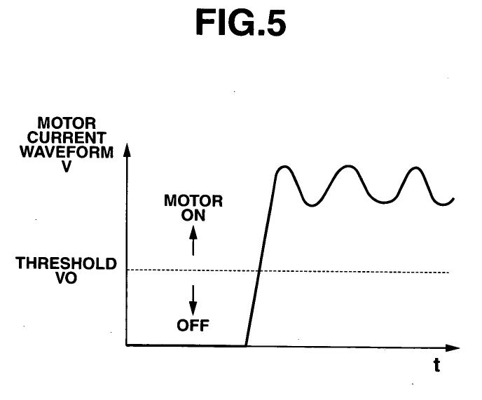

More specifically, in the flash memory 26 is recorded the threshold voltage V0 of the current waveform to be detected by the current-waveform detecting circuit 31, as shown in FIG. 5. The threshold voltage V0 denotes a voltage value of current waveform at which the zoom motor 12 starts its rotation, and which has experimentally been determined. CPU 13 determines that the current waveform has risen, or the current waveform becomes ON, when the current waveform which rises with rotation of the zoom motor has reached the threshold voltage V0. Therefore, when the current waveform has not yet reached the threshold voltage V0 (when the zoom motor 12 has not yet started its rotation) immediately after the switches are turned on, CPU 13 makes a judgment of NO at step S102, and keeps the recording operation inactive at step S103.

When the current waveform has reached the threshold voltage V0 (or when the zoom motor has started its rotation), CPU 13 determines that the current waveform has risen to the threshold voltage, or that the current waveform becomes ON (YES: at step S102). Then, the operation of CPU 13 advances from step S102 to S104, where the recording operation starts, and the audio signal processing circuit 32 processes noises transferred from the microphone 34 at step S104, which noises are produced by rotation of the zoom motor 12 and/or the driven zoom lens. The sound data (zoom sound data) obtained by the audio signal processing circuit 32 is successively stored in the flash memory 26 at step S105. Thereafter, the processes at steps S102, S104 and S105 are repeatedly performed. And the processes at steps S102, S104 and S105 are repeatedly performed as long as the current waveform keeps ON, and zoom sound data which is obtained after the current waveform has risen and reached the threshold voltage V0 (current waveform is ON) is stored in the flash memory 26.

When the zoom motor 12 rotates in the normal direction to move the zoom lens in the lens block 11 from the initial position to the critical position, and then rotates in the reverse direction to return the zoom lens to the initial position again, the motor driver 16 turns on the switches 1, 3 or turns off all the switches 1 to 4, whereby brake is put on the zoom motor 12 and the current waveform declines. When the current waveform has declined to less than the threshold voltage V0 (or when the motor driver 16 stops rotation of the zoom motor 12), CPU 13 makes a judgment of NO at step S102, and advances to step S103 to stop the recording operation.

In the zoom sound recording process, zoom sound data obtained while the zoom motor 12 rotates in the normal direction to move the zoom lens from the initial position to the critical position, and zoom sound data obtained while the zoom motor 12 rotates in the reverse direction to move the zoom lens from the critical position to the initial position are stored in the flash memory 26.

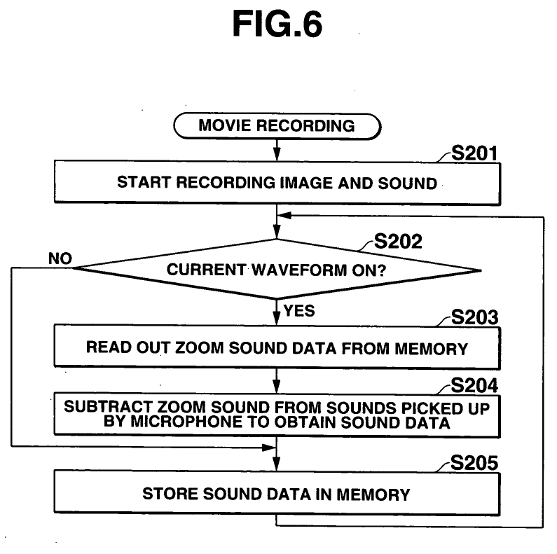

When the user sets the movie recording mode and operates the shutter key for the first time, CPU 13 executes the program to perform processes in accordance with the flow chart shown in FIG. 6. First, an image recording operation and sound recording operation start and image data is successively stored in the external memory 25 at step S201. It is judged at step S202 in the similar manner to step S102, whether or not the current waveform has risen to the threshold voltage V0 or has become ON. When the user does not operate the zoom key, or when the current waveform has not yet become ON even through the zoom key is operated, the judgment of NO is made at step S202. Thereafter, the operation advances to step S205, where sound data detected by the microphone 34 is stored in the external memory 25. At this time, the zoom motor 12 does not work, and, therefore noise is not produced by rotation of the zoom motor 12, and no noise is stored in the external memory 25 together with the sound data.

When the user operates the zoom key, and the current waveform rises to the threshold voltage V0, or the current waveform becomes ON to make the zoom motor 12 rotate, zoom sound data corresponding to the direction of motor rotation is read out from the flash memory 26 at step S203. A subtracting process is performed to subtract zoom sound from sound data from the surroundings obtained by the microphone 34 and audio signal processing circuit 32. The sound data subjected to the subtracting process is stored in the external memory 25 at step S204. In other words, the noises (zoom sound data) produced by rotation of the zoom motor 12 are subtracted from sound data actually entered from the microphone 34 during the course of the process at step S204. Then, sound data with the zoom noise deleted is stored in the external memory 25.

When the zoom lens in the lens block 11 moves to the critical position, or the user ceases from operating the zoom key, the motor driver 16, for example, turns on the switches 1, 3 or turn off all the switches 1 to 4, whereby brake is put on the zoom motor 12, or the current waveform goes down. When the current waveform has decayed to less than the threshold voltage V0 (or when the motor driver 16 actually stops), the judgment of NO is made at step S202, whereby the operation advances to the process at step S205 without performing the processes at steps S203 and S204. Therefore, even though the current waveform has decayed to less than threshold voltage V0, or the zoom motor 12 already halts its rotation, the subtracting process is not performed at step S204.

The second shutter operation by the user ceases storing the image data and sound data in the external memory 25.

### Second Embodiment

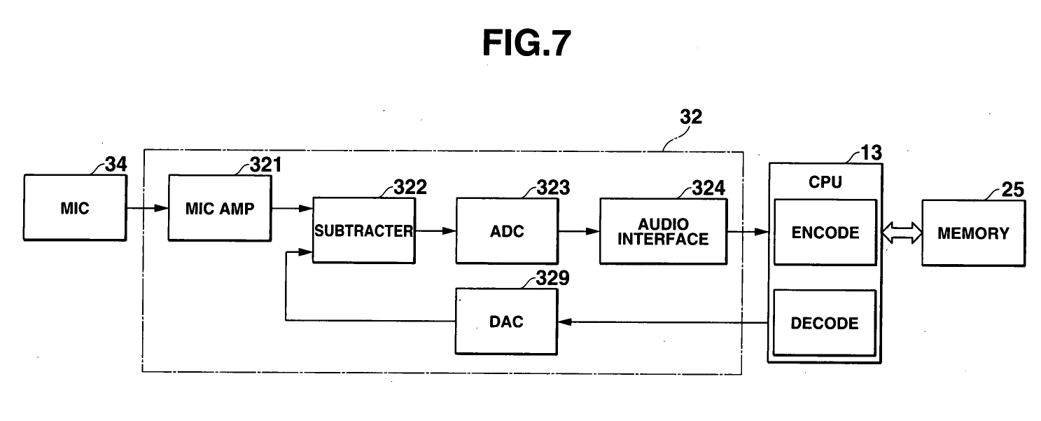

(1) FIG. 7 is a block diagram showing a circuit configuration of a main portion of an electronic camera according to the second embodiment of the invention. In the second embodiment, the subtracting process is performed in the audio signal processing circuit 32 connected to the microphone 34 and CPU 13. The audio signal processing circuit 32 comprises a microphone amplifier (MIC AMP) 321, subtracter 322, AD converter (ADC) 323, audio interface 324 and DA converter (DAC) 329.

In the zoom-sound recording mode, zoom sound entered from the microphone 34 is amplified by the microphone amplifier 321, and the amplified zoom sound is converted to zoom sound data by the AD converter 323. At this time, the subtracter 322 is made inactive. The zoom sound data is sent to CPU 13 through the audio interface 324. CPU 13 encodes the zoom sound data obtained during a time duration between the time at which the current waveform has reached the threshold voltage V0 (current waveform ON) and the time at which the current waveform decays to less than the threshold voltage V0 (current waveform OFF), and stores the encoded zoom sound data in the flash memory 26.

In the movie recording mode, when the current waveform reaches the threshold voltage V0 or becomes ON, CPU 13 reads out zoom sound data from the flash memory 26 and decodes the read out data. The decoded zoom sound data is converted into an analog zoom sound waveform by DA converted. The subtracter 322 subtracts the zoom sound waveform from the sound waveform entered from the microphone 34 through the microphone amplifier 321. AD converter 323 receives and converts the sound waveform with the zoom sound waveform subtracted into sound data. The sound data is supplied to CPU 13 through the audio interface 324 to be encoded and stored in the external memory 25.

In the second embodiment, a noise reducing process is precisely executed in response to noises produced by rotation of the zoom motor 12. Further, CPU 13 is not required to perform the subtracting process, and therefore it is possible to decrease burden of performing processes, imposed on CPU 13.

(2) In the first and second embodiment described above, the invention is applied to the noise reducing process for reducing noises produced by rotation of the zoom motor 12. The invention may also be applied to the noise reducing process for reducing noises produced by rotation of AF motor for driving the focus lens or noises produced by driving the zoom lens. In this case, the operations of “zoom motor” and “zoom sound” are replaced with those of “AF motor” and “AF sound” in the flow charts of FIGS. 4 and 6 (modified flow charts), respectively. The noise reducing process may be performed in accordance with the modified flow charts. The present invention may be used to reduce not only noises produced by DC motor but also noises produced by a stepping motor.

(3) When the shutter and aperture control mechanism are driven by a current waveform, or in a camera having a hard disc driven by a current waveform, the similar replacement in the flow charts allows to use the invention to reduce the noises produced in the above mechanism or camera. The present invention may be used not only in the camera but also in various apparatuses or recording apparatuses having a hard disc driven by the current waveform. Further, in the first and second embodiment, the noise reducing process which subtracts the previously stored noise data from sound data is used, but such noise reducing process may be used, that decreases a sound level detected by the microphone to a certain level (or prohibits a recording process), performs a certain filtering process, or adds noise waveform data to a sound waveform from the microphone in the opposite phase.

### Third Embodiment

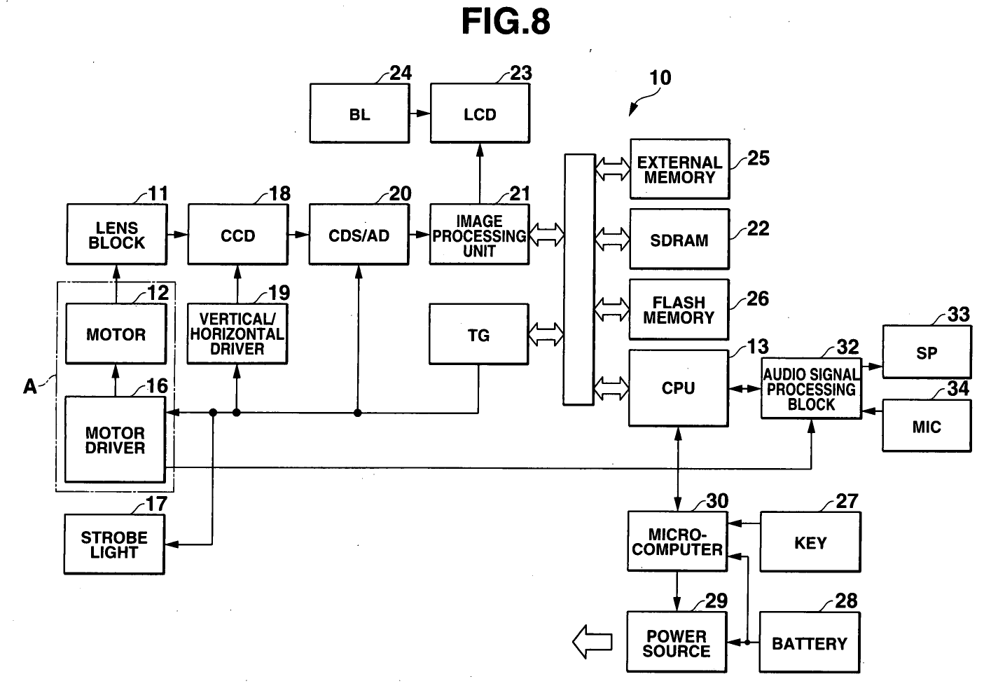

FIG. 8 is a block diagram showing a circuit configuration of a digital camera according to the third embodiment of the invention. The digital camera 10 has general functions such as AE, AWB and AF. The lens block 11 includes an optical system having a zoom lens and focus lens, and a driving mechanism for driving the optical system. The zoom lens and focus lens in the optical system are driven along the direction of the optical axis by a zoom motor (DC motor) 12 provided in the driving mechanism. CPU 13 controls whole operation of the digital camera 10, and is connected with a motor driver 16 through a bus 14 and a timing signal generator (TG) 15. The motor driver 16 drives the zoom motor 12 on the basis of a timing signal which the timing signal generator 15 generates in accordance with an instruction given by CPU 13. The current waveform of electric current supplied to the zoom motor 12 (a voltage waveform of the motor driver 16) is transferred to an audio signal processing block 32 to be described later. The strobe light 17 is also driven by the timing signal generated by the timing signal generator 15. Further, though not shown in FIG. 8, there are provided a focus motor for driving the focus lens, a motor driver, a shutter, a mechanically controlled aperture, and a driving mechanism for driving these elements.

The digital camera 10 has CCD 18 serving as an image pick-up element. CCD 18 is disposed on the optical axis of the lens block 11. An image of an object to be photographed is focused on a light receiving surface of CCD 18. CCD 18 is driven by a vertical/horizontal driver 19 on the basis of the timing signal which is generated by the timing signal generator 15 in accordance with the instruction given by CPU 13, whereby an analog photographed image signal corresponding to the optical image of the object is obtained and output to the unit circuit 20. The unit circuit 20 comprises CDS circuit for removing noises involved in an output signal from CCD18, using the correlated double sampling method, and A/D converter which converts the photographed image signal with noises removed into a digital signal. The digitalized photographed-image signal is output to an image processing unit 21. The image processing unit 21 performs a pedestal clumping process on the input photographed-image signal, and separates the processed signal into a luminance (Y) signal and a color-difference (UV) signal.

Further, the image signal is subjected to digital signal processes for enhancing image quality, such as an automatic white balance control process, edge enhancing process, and pixel interpolating process in the image processing unit 21. YUV data converted by the image processing unit 21 is successively stored in SDRAM 22, and is converted into a video signal for every storage of image data of one frame in REC through mode, and further sent to a liquid crystal display monitor (LED) 23 provided with a back light, whereby a through image is displayed on LED 23.

In the still-image photographing mode, triggered by a shutter-key operation, CPU 13 gives CCD 18, the vertical/horizontal driver 19, unit circuit 20 and image processing unit 21 an instruction of switching a through-image photographing mode to the still-image photographing mode. Image data obtained during the course of the photographing process and temporarily stored in SDRAM 22 in the still-image photographing mode is compressed by CPU 13 to be finally recorded in the external memory 25 as a still-image file in a certain format. Further, in the movie recording mode, plural pieces of image data successively stored in SDRAM 22 during a time between the first and second shutter-key operation are successively compressed by CPU 13 and recorded in the external memory 25 as a moving image file. The still-image file and moving image file recorded in the external memory 25 are read out and extended in CPU 13 in response to a selecting operation by the user, and expanded on SDRAM 22 as YUV data to be displayed on the liquid crystal display monitor 23.

In the flash memory 26 are stored various sorts of programs for CPU 13 to control the above elements and units, including programs for controlling AE, AF and AWB adjusting operation and a data-communication program, and further various sorts of programs such as a moving-image photographing program used in the movie recording mode.

The digital camera 10 comprises the key input unit 27, rechargeable battery 28 such a nickel-hydride battery, power control circuit 29 for supplying electric power of the battery to various elements and units, and the micro-computer 30 for controlling the above elements and units. The key input unit 27 includes plural operation keys and switches such as a power switch, mode selecting key, shutter key, and zoom key. The micro-computer 30 scans constantly to judge whether any one of operation keys in the key input unit 27 has been operated. When one of operation keys has been operated by the user, the micro-computer 30 sends CPU 13 an operation signal corresponding the operated operation key. The zoom key is a key of a seesaw-mechanism type, having a “+” and “−” position.

The digital camera 10 has a recording function of recording sounds from the surroundings in the movie recording mode. CPU 13 is connected with the speaker (SP) 33 and microphone (MIC) 34 through an audio signal processing block 32. The audio signal processing block 32 processes a sound waveform entered from the microphone 34, and inputs sound waveform data to CPU 13 in the movie recording mode. CPU 13 compresses sound waveform data supplied from the audio signal processing block 32 during a time between the first and second shutter key operation in the movie recording mode to produce a moving image file with sounds accompanied, including the compressed sound data and compressed moving image data, and records the produced moving image file in the external memory 25. The moving image file with sounds accompanied, recorded in the external memory 25 is processed in PLAY mode such that sound data is converted into a sound waveform by the audio signal processing block 32 to be reproduced through the speaker 33, while the moving image data is being reproduced. Sounds may be recorded not only while a moving image is photographed but also while a recording operation is performed in the still-image photographing mode for photographing a moving image with sounds accompanied, or while the recording operation is performed in the recording mode or in the after recording mode.

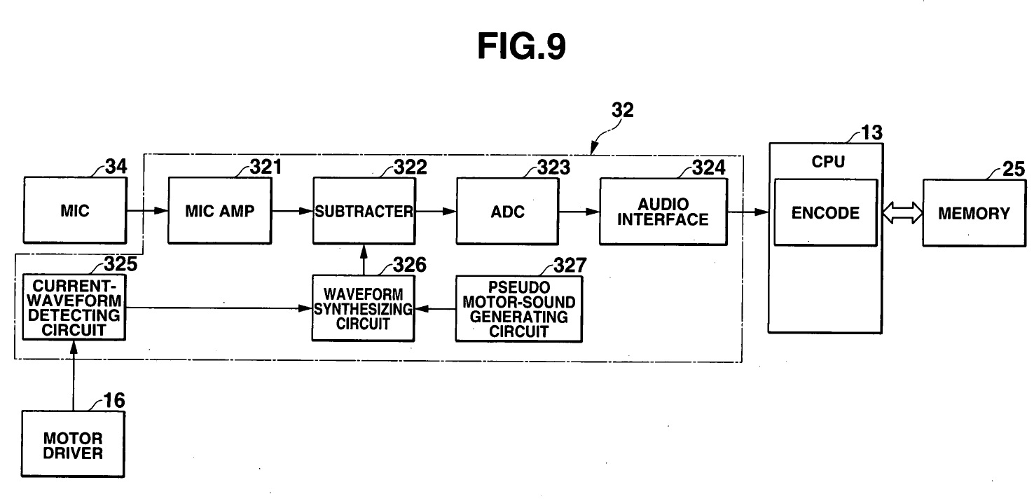

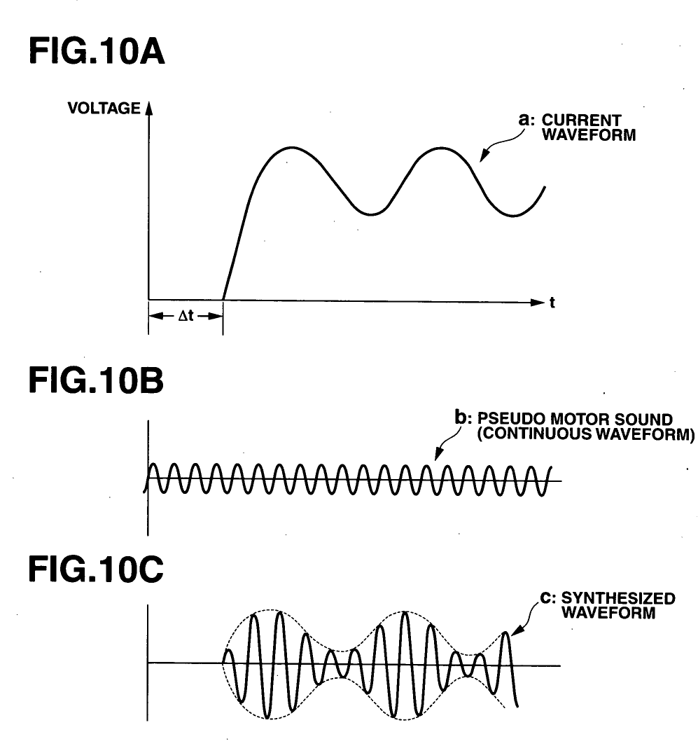

FIG. 9 is a block diagram showing the audio signal processing block 32 in detail. As shown in FIG. 9, the audio signal processing block 32 is connected with the microphone 34 and CPU 13. The audio signal processing block 32 comprises a microphone amplifier (MIC AMP) 321, subtracter 322, AD converter (ADC) 323, and audio interface 324, and further comprises a current-waveform detecting circuit 325, waveform synthesizing circuit 326 and pseudo motor-sound generating circuit 327. The microphone amplifier 321 amplifies a sound waveform sent from the microphone 34 and outputs the amplified sound waveform to the subtracter 322. The current-waveform detecting circuit 325 detects a current waveform (voltage waveform output from the motor driver 16) “a” supplied to the zoom motor 12 (shown in FIG. 10A) and outputs the detected waveform to the waveform synthesizing circuit 326. The pseudo motor-sound generating circuit 327 serves to generate at all times a pseudo motor-sound “b” having a waveform shown in FIG. 10B. The pseudo motor-sound “b” is a sound having the same or similar constant frequency as noises obtained by analyzing noises produced by the zoom motor 12 of the digital camera 10 rotating in the calm surroundings. The waveform synthesizing circuit 326 accumulates and synthesizes the current waveform “a” shown in FIG. 10A and the pseudo motor-sound “b shown in FIG. 10B to obtain a synthesized waveform “c” shown in FIG. 10C. The synthesized waveform “c” is supplied to the subtracter 322. The subtracter 322 subtracts the synthesized waveform “c” supplied by the waveform synthesizing circuit 326 from the sound waveform sent from the microphone amplifier 321. The resultant waveform is converted into digital data by AD converter 323, and the digital data is input to CPU 13 through the audio interface 324, whereby the digital data is encoded and stored in the external memory 25 together with moving image data.

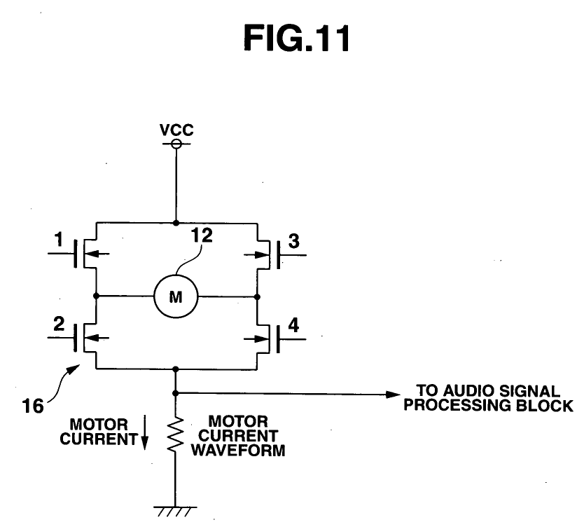

FIG. 11 is a view showing a circuit of the section “A” surrounded by a broken line in FIG. 8, including the zoom motor 12 and motor driver 16. The motor driver 16 comprises a parallel connection of a series connection of switches 1 and 2 and a series connection of switches 3 and 4, and the zoom motor 12 is connected between a connecting point of the switches 1 and 2 and a connecting point of the switches 3 and 4, as shown in FIG. 11. When the zoom key is operated at its “+” position to turn on the switches 1 and 4, the zoom motor 12 rotates in the normal direction, and when the zoom key is operated at its “−” position to turn on the switches 2 and 3, then the zoom motor 12 rotates in the reverse direction. A current waveform appeared across a register at the time when the switches 1 and 4 are turned on or at the time the switches 1 and 4 are turned on is detected between the switches 2, 4 and the earth, and supplied to the current-waveform detecting circuit 325.

In the arrangement according to the third embodiment of the invention, when the user sets the movie recording mode and operates the shutter key for the first time, CPU 13 starts an image and sound recording operation in accordance with the moving-image photographing program, and successively records image data in the external memory 25. Meanwhile, sounds from the surroundings are picked up by the microphone 34 and are transferred to CPU 13 through the microphone amplifier 321, subtracter 322, AD converter 323, audio interface 324. Sound data processed in CPU 13 is recorded on the external memory 25.

During the moving image photographing operation with no zoom key operated by the user, the current waveform “a” is not generated and output from the current-waveform detecting circuit 325. Therefore, since no data is output from the waveform synthesizing circuit 326 even though the waveform synthesizing circuit 326 performs an accumulating process, a synthesized waveform “c” is output from the waveform synthesizing circuit 326 to the subtracter 322. As the result, no subtracting process is executed by the subtracter 322, and sounds picked up by the microphone 34 are recorded on the external memory 25 without any modification made thereto. At this time, since the zoom motor 12 is not operating, no noise is produced by rotation of the zoom motor 12 and is recorded together with the sound data.

When the user operates the zoom key, the switches 1, 4 or switches 2, 3 in the motor driver 16 are turned on to supply electric current from the power source 29 to the zoom motor 12. The current waveform “a” supplied to the zoom motor 12 rises with a time lag Δt as shown in FIG. 10A, and the current waveform “a” which rises with a time lag Δt is entered to the waveform synthesizing circuit 326 through the current-waveform detecting circuit 325. Then, the waveform synthesizing circuit 326 accumulates and synthesizes the pseudo motor-sound “b” with the current waveform “a” rising with a time lag Δt to obtain a synthesized waveform “c”, and outputs the synthesized waveform “c” to the subtracter 322. The subtracter 322 subtracts the synthesized waveform “c” from sound waveform entered from the microphone 34 through the microphone amplifier 321, and outputs the resultant waveform to AD converter 323.

Therefore, during the course of subtracting process in the subtracter 322, the synthesized waveform “c” is subtracted from the sound waveform entered from the microphone 34 from the time at which the current waveform “a” rises with a time lag Δ t. Since the time at which the current waveform “a” rises with a time lag Δt coincides with the time at which the zoom motor 12 starts its rotation, and noises are produced by rotation of the zoom motor, the subtracting process starts at such time subtracting the synthesized waveform “c” from the sound waveform, whereby the time when the subtracting process starts can be made to precisely coincide with the time when the zoom motor starts producing noises.

When the current waveform “a” varies as shown in FIG. 10A while the zoom motor rotates, the synthesized waveform “c” varies as shown in FIG. 10C along with the variation of the current waveform “a”. Therefore, during the course of subtracting process in the subtracter 322, the sound waveform entered from the microphone 34 is subtracted by the synthesized waveform “c” varying with variation of the current waveform “a”. Since the rotation of the zoom motor 12 varies with variation of the current waveform “a”, noises produced by rotation of the zoom motor 12 vary accordingly. Therefore, since the subtracter 322 subtracts the synthesized waveform “c” varying with variation of the current waveform “a”, noises are precisely reduced in accordance with variation of noises.

When the zoom lens of the lens block 11 moves to the critical position, or when the user ceases from operating the zoom-key, the motor driver 16, for example, turns on the switches 1, 3 or turns off all the switches 1 to 4, whereby brake is put on the zoom motor 12 and the current waveform “a” decays, reaching the zero level. When the current waveform “a” begins to decay, the zoom motor 12 decreases its rotation, and therefore noises produced by the rotation of the zoom motor become weak. The subtracter 322 subtracts the synthesized waveform “c” varying with decay of the current waveform “a” from the sound waveform, whereby noises can precisely be decreased in accordance with decrease in noises. Since the zoom motor 12 stops at the time when the current waveform “a” has reached the zero level, no noise is generated by operation of the zoom motor 12. When the current waveform “a” has reached the zero level, the current waveform “a” output from the current-waveform detecting circuit 325 to the synthesizing circuit 326 falls to the zero level, whereby the output of the synthesizing circuit 326 becomes zero level. As the result, the output from the synthesizing circuit 326 to the subtracter 322 becomes zero level, and therefore no subtracting operation is executed by the subtracter 322. As described above, the time at which the subtracter 322 ceases its subtracting operation can precisely be made to coincide with the time when noises decreases to the zero level.

Noise reducing operation by subtracting noises can be executed only during a time duration which precisely coincides with a time duration defined by the time when the zoom motor 12 starts producing noises and the time when the zoom motor 12 stops production of noises, and also the noise reducing operation can be executed by subtracting a synthesized waveform that is precisely coincide with noise variation from the noises actually generated.

The second shutter-key operation by the user ceases recording the image data and sound data on the external memory 25.

### Fourth Embodiment

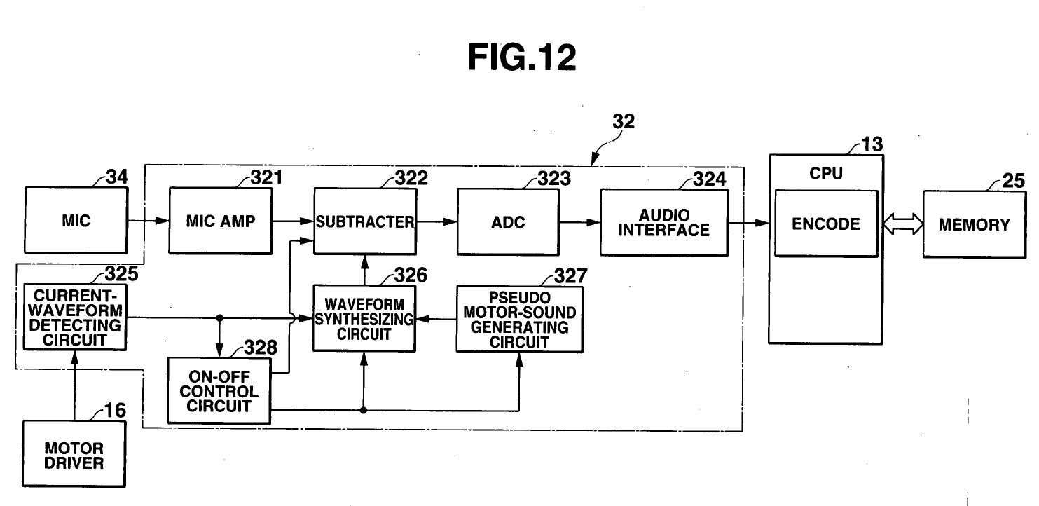

FIG. 12 is a block diagram showing in detail a circuit diagram of an audio signal processing block 32 in the fourth embodiment of the invention. The audio signal processing block 32 in the fourth embodiment is different from the audio signal processing block in the third embodiment shown in FIG. 9, in the arrangement that there is provided an ON-OFF control circuit 328. In FIG. 12, like elements as those in FIG. 9 are designated by like reference numerals, and their description will be omitted. ON-OFF control circuit 328 serves as a control circuit which brings the subtracting function of the subtracter 322, and waveform synthesizing circuit 326 and pseudo motor-sound generating circuit 327 to an inactive state, when the current waveform “a” input from the current-waveform detecting circuit 325 is at the zero level.

In the arrangement according to the fourth embodiment, when the user sets the movie recording mode and performs the first shutter-key operation, CPU 13 operates in accordance with the moving-image photographing program to start image and sound recording, whereby image data is successively recorded on he external memory 25. Meanwhile, sounds from the surroundings are picked up by the microphone 34 and transferred to CPU 13 through the microphone amplifier 321, subtracter 322, AD converter 323, and audio interface 324, whereby sound data is successively recorded on the external memory 25.

During the moving-image photographing operation with no zoom key operation performed by the user, no current waveform “a” is generated and is output from the current-waveform detecting circuit 325, whereby the ON-OFF control circuit 328 puts the subtracting function of the subtracter 322, the waveform synthesizing circuit 326, and pseudo motor-sound generating circuit 327 in an inactive state. As the result, electric power to be consumed by the subtracter 322, waveform synthesizing circuit 326, and pseudo motor-sound generating circuit 327 is saved. The subtracter 322 does not perform its subtracting operation, and the sounds picked up by the microphone 34 are recorded on the external memory 25 without any modification made thereto. At this time, the zoom motor 12 is not in operation, and therefore no noises are produced by the operation of the zoom motor 12, and recorded together with sounds from the surroundings.

When the user operates the zoom key, the switches 1, 4 or switches 2, 3 in the motor driver 16 are turned on to supply electric current from the power source 29 to the zoom motor 12. The current waveform “a” of the current supplied to the zoom motor 12 rises with a time lag Δt as shown in FIG. 10A, and the current waveform “a” which rises with a time lag Δt is entered to the waveform synthesizing circuit 326 and ON-OFF control circuit 328 through the current-waveform detecting circuit 325. Then, ON-OFF control circuit 328 brings the subtracting function of the subtracter 322, the waveform synthesizing circuit 326, and pseudo motor-sound generating circuit 327 to an active state. The waveform synthesizing circuit 326 accumulates and synthesizes the pseudo motor-sound “b” and the current waveform “a” rising with a time lag Δt to obtain a synthesized waveform “c”, and outputs the synthesized waveform “c” to the subtracter 322. The subtracter 322 subtracts the synthesized waveform “c” from sound waveform entered from the microphone 34 through the microphone amplifier 321, and outputs the resultant waveform to AD converter 323.

Therefore, during the course of subtracting process in the subtracter 322, the synthesized waveform “c” is subtracted from the sound waveform entered from the microphone 34 from the time at which the current waveform “a” rises with a time lag Δ t. Since the time at which the current waveform “a” rises with a time lag Δt coincides with the time at which the zoom motor 12 starts its rotation, and noises are produced by rotation of the zoom motor 12, the subtracting process starts at such time, subtracting the synthesized waveform “c” from the sound waveform, whereby the time at which the subtracting process starts can be made to precisely coincide with the time when the zoom motor 12 starts producing noises.

When the zoom lens of the lens block 11 moves to the critical position, or when the user ceases from operating the zoom-key, whereby the current waveform “a” reaches the zero level, the zoom motor 12 stops its rotation, producing no noises. When the current waveform “a” has reached the zero level, the current waveform “a” output from the current-waveform detecting circuit 325 to the synthesizing circuit 326 falls to the zero level, and ON-OFF control circuit 328 brings the subtracting function of the subtracter 322, waveform synthesizing circuit 326, and pseudo motor-sound generating circuit 327 to an inactive state. As described above, the time at which the subtracter 322 ceases its subtracting operation can be made to precisely coincide with the time when noises decreases to the zero level.

### Modification to Fourth Embodiment

In the forth embodiment of the invention, an accumulating circuit is used as the waveform synthesizing circuit 326 in the similar manner to the third embodiment, which circuit serves to accumulate and synthesize the current waveform “a” and motor sound “b”. But ON-OFF control circuit 328 is used additionally in the fourth embodiment, and therefore, even if an adding circuit which adds and synthesizes the current waveform “a” to motor sound “b” is used as the waveform synthesizing circuit 326, the substantially same features and advantages may be obtained.

### Other Embodiments

(1) In the above third and fourth embodiment, the current-waveform detecting circuit 325 provided in the audio signal processing block 32 detects a current waveform “a”, and the pseudo motor-sound generating circuit 327 generates a pseudo motor sound “b”. These current waveform “a” and pseudo motor sound “b” are processed in the waveform synthesizing circuit 326 to generate a synthesized waveform “c”. Then, the synthesized waveform “c” is subjected to the subtracting process by the subtracter 326 to be subtracted from the sound waveform. In place of provision of the above elements in the audio signal processing block 32, modification may be made such that a program for CPU 13 to realize the functions of the elements in the audio signal processing block 32 is previously stored in the flash memory 26, and that CPU 13 operates in accordance wuth the program to detect the current waveform “a”, generate the pseudo motor sound “b”, obtain the synthesized waveform “c”, and subtract the synthesized waveform. “c” from sound waveform.

(2) In the above third and fourth embodiment, the invention which is applied to the noise reducing process for reducing noises produced by the zoom motor 12 has been described, but the invention may also be used in the noise reducing process for reducing noises produced by rotation of AF motor provided in the lens block 11 for driving the focus lens or for reducing noises generated while the focus lens is moving. In this arrangement, the motor driver 16 shown in FIG. 2 may be used as a driver for driving AF motor, and the pseudo motor-sound generating circuit 327 may be used to generate pseudo motor sound of AF motor. Further, the invention may be used in the noise reducing process not only for reducing noises of DC motor but also for reducing noises of a stepping motor.

(3) When the shutter and aperture control mechanism are driven by a current waveform, or in a camera having a hard disc driven by a current waveform, the similar replacement allows to use the invention to reduce the noises produced in the above mechanism or camera. The present invention may be used not only in the electronic camera but also in various apparatuses or recording apparatuses provided with a hard disc driven by the current waveform.

It will be apparent to those skilled in the art that various modifications and variations can be made to the present invention without departing from the spirit or scope of the invention. Thus, it is intended that the present invention cover the modifications and variations of this invention, provided they fall within the scope of the following claims and their equivalents.

What is claimed is:

1. An electronic camera comprising:
an image photographing unit for photographing a moving image;
a detecting unit for detecting sounds from the surroundings while the moving image is being photographed by the image photographing unit;
a recording unit for recording the moving image photographed by the image photographing unit and the sounds detected by the detecting unit;
an operating unit driven by a current;
a noise reducing unit for performing a noise reducing operation to reduce noises produced by operation of the operating unit; and
a control unit for judging, on the basis of a current waveform of the current for driving the operating unit, whether or not the noise reducing unit should perform the noise reducing operation.

2. The electronic camera according to claim 1, further comprising:
a zoom lens, wherein the operating unit comprises a zoom motor for driving the zoom lens.

3. A noise reduction device comprising:
an operating unit driven by a current;
a noise reducing unit for performing a noise reducing operation to reduce noises produced by operation of the operating unit; and
a control unit for judging, on the basis of a current waveform of the current for driving the operating unit, whether or not the noise reducing unit should perform the noise reducing operation.

4. The noise reduction device according to claim 3, wherein the control unit comprises:
a judging unit for judging whether or not the current waveform of the current for driving the operating unit is not less than a certain threshold value; wherein
the noise reducing unit performs a noise reducing operation, when the judging unit decides that the current waveform of the current for driving the operating unit is not less than the threshold value.

5. The noise reduction device according to claim 3, wherein the control unit controls, on the basis of the current waveform of the current for driving the operating unit, a timing at which the noise reducing unit starts performing a noise reducing operation.

6. The noise reduction device according to claim 3, wherein the control unit controls on the basis of the current waveform of the current for driving the operating unit, a timing at which the noise reducing unit ceases from performing a noise reducing operation.

7. The noise reduction device according to claim 3, wherein the operating unit comprises a electric motor.

8. The noise reduction device according to claim 3, further comprising:
a detecting unit for detecting sounds from the surroundings; and
a recording unit for recording the sounds detected by the detecting unit.

9. The noise reduction device according to claim 8, wherein the noise reducing unit comprises:
a storing unit for previously storing noises produced by operation of the operating unit; and
a subtracting unit for subtracting the noises stored in the storing unit from sounds detected by the detecting unit while noises are generated.

10. The noise reduction device according to claim 9, wherein the storing unit previously stores noises produced by operation of the operating unit when the current waveform of the current for driving the operating unit is not less than a certain threshold value.

11. A method of reducing noises comprising the steps of:
detecting a current waveform of a current for driving an operating unit; and
making a noise-reduction processing unit start a noise reduction process to reduce noises produced by operation of the operating unit, in response to detected current waveform of the current.

12. An electronic camera comprising:
an image photographing unit for photographing a moving image;
a detecting unit for detecting sounds from the surroundings while the moving image is being photographed by the image photographing unit;
a recording unit for recording the moving image photographed by the image photographing unit and the sounds detected by the detecting unit;
an operating unit driven by a current;
a pseudo-noise generating unit for generating pseudo noises similar to noises produced by operation of the operating unit;
a synthesized waveform generating unit for synthesizing a current waveform of the current for driving the operating unit and the pseudo noises generated by the pseudo-noise generating unit to produce a synthesized waveform noise; and
a subtracting unit for subtracting the synthesized waveform noise produced by the synthesized waveform generating unit from the sounds detected by the detecting unit.

13. The electronic camera according to claim 12, further comprising:
a zoom lens, wherein the operating unit comprises a zoom motor for driving the zoom lens.

14. A noise reduction device comprising:
a detecting unit for detecting noises from the surroundings;
an operating unit driven by a current;
a pseudo-noise generating unit for generating pseudo noises similar to noises produced by operation of the operating unit;
a synthesized waveform generating unit for synthesizing a current waveform of the current for driving the operating unit and the pseudo noises generated by the pseudo-noise generating unit to produce a synthesized waveform noise; and
a subtracting unit for subtracting the synthesized waveform noise produced by the synthesized waveform generating unit from the sounds detected by the detecting unit.

15. The noise reduction device according to claim 14, further comprising:
a recording unit for recording the sounds detected by the detecting unit.

16. The noise reduction device according to claim 14, wherein the operating unit comprises an electric motor.

17. The noise reduction device according to claim 14, wherein the synthesized waveform generating unit accumulates the current waveform of the current for driving the operating unit and the pseudo noises generated by the pseudo-noise generating unit to produce a synthesized waveform.

18. The noise reduction device according to claim 14, further comprising:
a control unit for detecting a current waveform of the current for driving the operating unit, and for bringing at least any one of the pseudo-noise generating unit, synthesized waveform generating unit and subtracting unit to an inactive state, when the detected current is at the zero level.

19. A method of reducing noises comprising the steps of:
detecting sounds from the surroundings;
generating pseudo noises similar to noises produced by operation of an operating unit driven by a current;
synthesizing a current waveform of the current for driving the operating unit and the generated pseudo noises to produce a synthesized waveform noise; and
subtracting the produced synthesized waveform noise from the sounds detected by the detecting unit.
